(19) United States
(12) Patent Application Publication
(10) Pub. No.: US 2024/0132782 A1
(43) Pub. Date: Apr. 25, 2024

(54) WASTE WOOD SLEEPER PYROLYSIS APPARATUS OF HYBRID HEATING TYPE

(71) Applicant: KOREA RAILROAD RESEARCH INSTITUTE, Uiwang-si (KR)

(72) Inventors: Tae Hoon KOH, Yongin-si (KR); Myung SAGONG, Yongin-si (KR); Jae Young LEE, Suwon-si (KR); Dong Geun LEE, Anyang-si (KR); Hanju YOO, Suwon-si (KR)

(21) Appl. No.: 18/487,753

(22) Filed: Oct. 15, 2023

(30) Foreign Application Priority Data
Oct. 23, 2022 (KR) 10-2022-0137105
Jun. 21, 2023 (KR) 10-2023-0080046

(51) Int. Cl. C10B 53/02; C10B 47/02; C10B 57/18

(52) U.S. Cl. CPC C10B 53/02; C10B 47/02; C10B 57/18

(57) ABSTRACT

A waste wood sleeper pyrolysis apparatus of a hybrid heating type includes a plurality of reactor containers arranged side by side, each having a space in which a waste wood sleeper is placed, a movement rail arranged parallel to an end of one side and an end of the other side of each of the plurality of reactor containers, and a microwave applicator coupled to the movement rail and including a plurality of microwave generators that move to upper portions of the plurality of reactor containers to transmit microwaves into the plurality of reactor containers.

### BACKGROUND

The present disclosure relates to a waste wood sleeper pyrolysis apparatus of a hybrid heating type.

At a time when the social importance of reducing energy consumption and regulating exhaust gas emission is increasing, interest in a railway system that is a low-carbon transportation system is increasing, but pollutants emitted from the operation of diesel railway vehicles, underground urban railway stations, and railway facilities are becoming a social problem.

In the railway infrastructure field, wood sleepers that are creosote-treated toxic pollutants are considered as the main culprit of soil pollution, and hundreds of thousands of waste wood sleepers are produced every year, but the waste wood sleepers may not be recycled and are instead left in open storage without being processed due to the enormous processing costs.

Waste wood sleepers, which are inevitably generated during railway improvement projects or maintenance processes, may be recycled into biochar and biomass that is a raw material for environmental filters (activated carbon) in accordance with the Waste Management Act, but there is no commercialized process technology yet.

Korea Patent No. 10-0936137 “A Crushing Tongs of Waste Wood Sleepers for Heavy Equipment”, which is the first conventional technology, may increase driving efficiency by using a single hydraulic cylinder, and relates to crushing tongs of waste wood sleepers for heavy equipment which may crush multiple waste wood sleepers and transport and cut the multiple waste wood sleepers at the same time, thereby increasing work efficiency.

the conventional technology provides the crushing tongs for crushing the waste wood sleepers but does not provide a method of recycling the crushed waste wood sleepers.

Korea Patent No. 10-0916980 “Incision Device of Waste Wood Sleepers”, which is a second conventional technology, consists of a horizontal cutter blade and a vertical cutter blade that may be disassembled and assembled such that a waste wood sleeper may be cut into two pieces in a longitudinal direction, two pieces in a horizontal direction, or four pieces in the longitudinal/horizontal direction, and relates to a waste wood sleeper cutting device that may cut multiple waste wood sleepers at the same time, thereby increasing work efficiency. However, the second conventional technology also does not provide a method of recycling the waste wood sleepers through cutting.

Korea Patent Application No. 10-2012-0134844, “SYSTEM FOR TREATMENT OF WASTE WOOD SLEEPER USING THERMAL ABSTRACTION”, which is the third conventional technology, relates to a waste wood sleeper treatment device and a method thereof by using heat extraction to reduce the contamination concentration of the waste wood sleepers (waste wood sleepers among sleepers) contaminated with oil and preservatives. However, the third conventional technology may reduce the contamination concentration of in the waste wood sleepers by applying high-temperature heat extraction technology, but does not provide a recycling technology for the waste wood sleepers themselves.

Korea Patent No. 10-1482734, “REPRODUCTION APPARATUS FOR SLEEPERS”, which is the fourth conventional technology, relates to a waste wood sleeper regeneration device having a structure that allows fast cutting of waste woods and smooth cutting of surfaces thereof without separate surface grinding of the waste woods, and to this end, in order to quickly cut the transported waste wood sleeper and prevent motor load, cutter blades are arranged side by side at the upper front and lower rear of each headstock such that upper and lower sides of the waste wood sleepers may be cut individually to quickly cut the transported waste wood sleepers and prevent motor load. However, the fourth conventional technology does not provide a method of recycling the crushed waste wood sleepers like the first and second conventional technologies.

### SUMMARY

The present disclosure provides a waste wood sleeper pyrolysis apparatus of a hybrid heating type that reduces carbon emissions during a process of recycling waste wood sleepers installed on railway tracks and provides eco-friendly adsorption materials (Biochar, activated carbon) and/or renewable energy.

According to an aspect of the present disclosure, a waste wood sleeper pyrolysis apparatus of a hybrid heating type includes a plurality of reactor containers arranged side by side, each having a space in which a waste wood sleeper is placed, a movement rail arranged parallel to an end of one side and an end of the other side of each of the plurality of reactor containers, and a microwave applicator coupled to the movement rail and including a plurality of micro wave generators that move to upper portions of the plurality of reactor containers to transmit microwaves into the plurality of reactor containers.

According to another aspect of the present disclosure, a method of pyrolyzing a waste wood sleeper by using a waste wood sleeper pyrolysis apparatus includes placing a microwave applicator on an upper portion of a first reactor container among a plurality of reactor containers, heating an inside of the first reactor container by using a plate-heater generation unit inside or outside the first reactor container, introducing the waste wood sleeper into the first reactor container, pyrolyzing the waste wood sleeper by applying power to the microwave applicator, moving the microwave applicator to an upper portion of a second reactor container adjacent to the first reactor container, and reducing a temperature in the first reaction container and recovering a bio-solid fuel generated inside the first reactor container.

The present disclosure has an effect of efficiently recycling waste wood sleepers through a waste wood sleeper pyrolysis apparatus of a hybrid heating type. In particular, since a movable (slidable) microwave heating unit is used, there is an effect of processing a large multiple waste wood sleepers introduced into a plurality of reactor containers at once.

### BRIEF DESCRIPTION OF THE DRAWINGS

Embodiments will be more clearly understood from the following detailed description taken in conjunction with the accompanying drawings in which:

FIG. 1 is a schematic diagram of a waste wood sleeper pyrolysis apparatus of a hybrid heating type according to an embodiment of the present disclosure;

FIG. 2 is a front view of a waste wood sleeper pyrolysis apparatus of a hybrid heating type according to an embodiment of the present disclosure;

FIG. 3 is a side view of a waste wood sleeper pyrolysis apparatus of a hybrid heating type according to an embodiment of the present disclosure;

FIG. 4 is an enlarged view of a portion A of FIG. 2;

FIG. 5 is a front view of a net according to an embodiment of the present disclosure;

FIG. 6 is a front view of a reactor container according to another embodiment of the present disclosure; and

FIG. 7 is a flowchart illustrating a waste wood sleeper pyrolysis method according to an embodiment of the present disclosure.

### DETAILED DESCRIPTION OF THE EMBODIMENTS

Hereinafter, embodiments of the present disclosure will be described in detail such that those skilled in the art to which the present disclosure belongs may easily implement the present disclosure with reference to the accompanying drawings. However, the present disclosure may be implemented in many different forms and is not limited to the embodiments to be described herein. In addition, in order to clearly describe the present disclosure with reference to the drawings, portions irrelevant to the description are omitted, and similar reference numerals are attached to similar portions throughout the specification.

When it is described that a portion is “connected” to another portion throughout the specification, this includes not only a case where the portion is “directly connected” to another portion but also a case where the portion is “indirectly connected” to another portion with another component therebetween.

When it is described that a member is “on” another member throughout the specification, this includes not only a case where a member is in contact with another member, but also a case where there is another member between the two members.

Throughout the specification of the present application, when it is described that a portion “includes” a certain component, this means that the portion may further include another component without excluding another component unless otherwise stated. Throughout the specification of the present disclosure, terms “about”, “substantially”, and so on are used to mean at or close to a numerical value when inherent manufacturing and material tolerances are given in the stated meaning, and are used to prevent unscrupulous infringers from taking unfair advantage of disclosures that state precise or absolute figures to aid understanding of the present disclosure. Terms “step of doing” or “step of” which are used throughout the specification, do not mean “step for”.

The present disclosure relates to a waste wood sleeper pyrolysis apparatus 10 of a hybrid heating type.

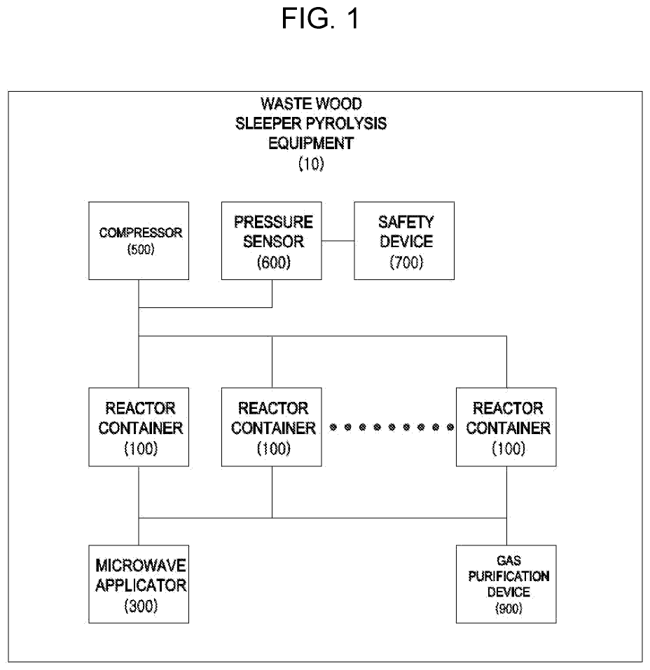

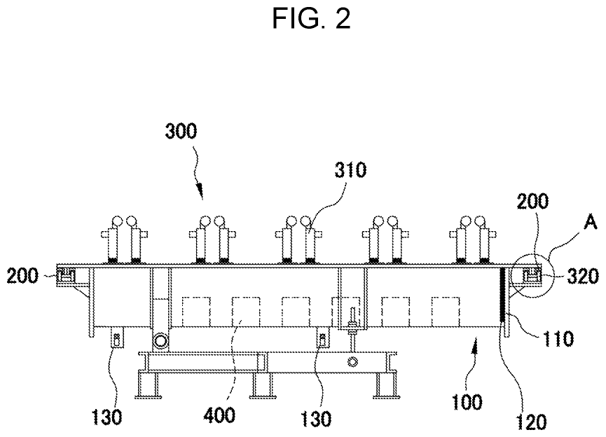

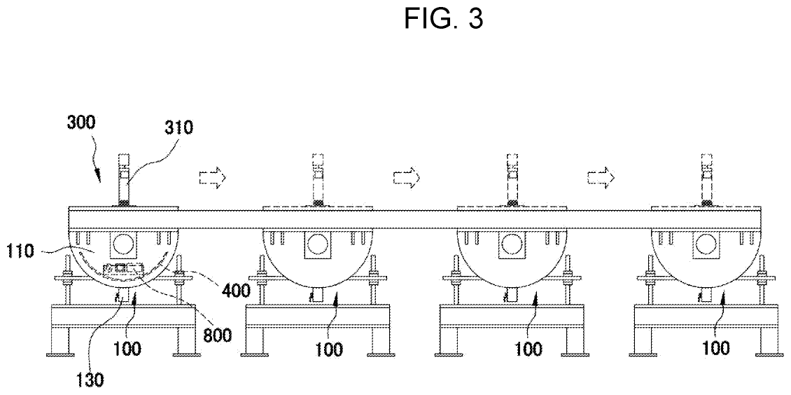

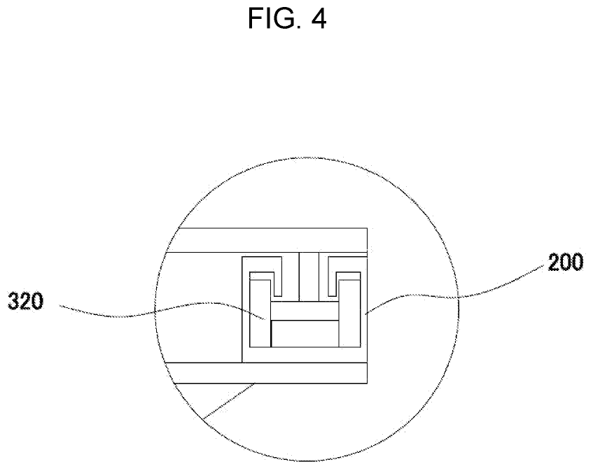

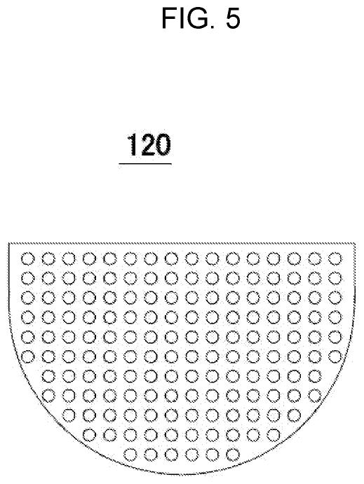

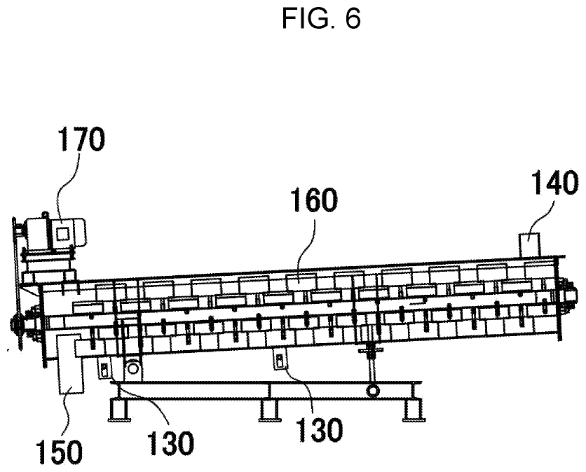

FIG. 1 is a schematic diagram of a waste wood sleeper pyrolysis apparatus of a hybrid heating type according to an embodiment of the present disclosure, FIG. 2 is a front view of the waste wood sleeper pyrolysis apparatus of a hybrid heating type according to an embodiment of the present disclosure, FIG. 3 is a side view of the waste wood sleeper pyrolysis apparatus of a hybrid heating type according to an embodiment of the present disclosure, FIG. 4 is an enlarged view of a portion A of FIG. 2, FIG. 5 is a front view of a net according to an embodiment of the present disclosure, and FIG. 6 is a front view of a reactor container according to another embodiment of the present disclosure.

Hereinafter, a waste wood sleeper pyrolysis apparatus 10 of a hybrid heating type according to an embodiment of the present disclosure will be described with reference to FIGS. 1 to 4.

Referring to FIGS. 2 and 3, the waste wood sleeper pyrolysis apparatus 10 of a hybrid heating type includes a plurality of reactor containers 100, a movement rail 200, and a microwave applicator 300.

Each of the plurality of reactor containers 100 includes a space in which waste wood sleepers are placed. In addition, the plurality of reactor containers 100 may be arranged side by side with each other.

The movement rail 200 may be arranged parallel to an end of one side and an end of the other side of each of the plurality of reactor containers 100. The one side may be a 3-o'clock direction in FIG. 2, and the other side may be a 9-o'clock direction in FIG. 2.

The microwave applicator 300 may have both ends coupled to the movement rail 200, move to an upper portion of each of the plurality of reactor containers 100, and transmit microwaves to the inside of each of the plurality of reactor containers 100. For this purpose, the microwave applicator 300 includes a plurality of microwave generators 310 that generate microwaves. In addition, the microwave applicator 300 is preferably configured to completely cover an open upper surface of each of the plurality of reactor containers 100 to prevent microwaves generated by the plurality of microwave generators 310 from leaking to the outside.

The plurality of microwave generators 310 may set one or more of a phase and a frequency to be different from each other to prevent peaks and valleys of phases and frequencies of applied microwaves from overlapping and causing destructive interference.

In addition, upper surfaces of the plurality of reactor containers 100, that is, a surface on which the microwave applicator 300 is placed, may be formed of a transparent material to cause microwaves applied from the plurality of microwave generators 310 to pass therethrough, but the present disclosure is not limited thereto. In addition, the microwave applicator 300 may further include a quartz glass portion (not illustrated) at a portion in contact with each of the plurality of reactor containers 100. For example, the quartz glass portion may be placed at a portion where an upper circumference of each of the plurality of reactor containers 100 and the microwave applicator 300 are in contact with each other, but the present disclosure is not limited thereto. The quartz glass portion may be placed between each of the plurality reactor containers 100 and the microwave applicator 300 and may prevent microwaves from leaking to the outside.

Referring to FIG. 4, the microwave applicator 300 may include wheel portions 320 respectively coupled to one end and the other end of the movement rail 200. For example, as illustrated in FIG. 4, the movement rail 200 may be formed in a U-shape with an open upper portion to guide the movement of the wheel portions 320, and the wheel portions 320 are placed inside the microwave applicator 300 so as to move smoothly along the movement rail 200. In this case, the microwave applicator 300 may include a driver (not illustrated) and may be moved to an upper portion of each of the plurality of reactor containers 100 as the driver operates. For example, the driver may be directly connected to the wheel portions 320 to transfer driving force, but the present disclosure is not limited thereto, and the driver may move the microwave applicator 300 through a chain or belt.

The microwave applicator 300 may be placed on upper portions of the plurality of reactor containers 100 and operate to heat waste wood sleepers for a predetermined time, and the waste wood sleepers may be pyrolyzed during heating. After a predetermined time for pyrolysis elapses, the microwave applicator 300 may move to an upper part of the adjacent reactor container 100 to pyrolyze a waste wood sleeper placed inside the adjacent reactor container 100. Accordingly, the present disclosure has an effect that not only significantly saves production costs but also processes many waste wood sleepers at once.

Referring back to FIG. 3, the waste wood sleeper pyrolysis apparatus 10 may further include microwave absorbers 800 that are inside the plurality of reactor containers 100 and heat itself by microwave emitted from the plurality of microwave generators 310.

The microwave absorbers 800 absorb the microwaves output from the plurality of microwave generators 310 and generates heat, thereby generating heat and carbonizing the waste wood sleeper. In addition, the microwave absorbers 800 may each have various shapes depending on the shape of the inside of each of the plurality of reactor containers 100, such as a block shape, a cylinder shape, or a square pillar shape. For example, the microwave absorbers 800 may each be made of a mixture of silicon carbide, a binder, an antioxidant, and a sintering accelerator, and may generate heat of a high temperature through the property of silicon carbide that absorbs microwaves.

In addition, referring to FIG. 2, the waste wood sleeper pyrolysis apparatus 10 may further include a plurality of plate-heater generation units 400 respectively coupled to the plurality of reactor containers 100.

The plurality of plate-heater generation units 400 are configured to preheat the insides of the plurality of reactor containers 100 prior to pyrolyzing waste wood sleepers inside the plurality of reactor containers 100 through the microwave applicator 300.

The plurality of plate-heater generation units 400 may be respectively in close contact with inner and/or outer surfaces of the plurality of reactor containers 100 and may be formed in a longitudinal direction of the plurality of reactor containers 100. In this case, the plurality of plate-heater generation units 400 may each be formed in a plate shape, have a heating wire that internally generates heat, and be filled with a special powder with high heat conductivity, such as magnesia, but are not limited thereto.

Referring back to FIG. 1, the waste wood sleeper pyrolysis apparatus 10 may further include a gas purification device 900 that is connected to the plurality of reactor containers 100 and purifies and collects pollutant gases generated during a process of pyrolyzing waste wood sleepers. In other words, the pollutant gases, such as CO, CO₂, NO_{X}, SO_{X}, HCl, HF, and so on may be generated during the process of pyrolyzing the waste wood sleepers inside the plurality of reactor containers 100, and the gas purification device 900 may collect and purify the pollutant gases. In addition, the gas purification device 900 sequentially operates a plurality of reactor containers 100 by using the microwave applicator 300, and only one gas purification device 900 may be connected to the plurality of reactor containers 100 in which pyrolysis is in progress, and thus, the apparatus may be reduced in size.

In addition, the waste wood sleeper pyrolysis apparatus 10 may further include oxygen blocking units (not illustrated) that are respectively placed on upper portions of the plurality of reactor containers 100 and prevent oxygen from flowing into the plurality of reactor containers 100 from the outside. The oxygen blocking units may be configured to prevent oxidation (Ash) for a certain period of time when temperatures of the plurality of reactor containers 100 are lowered such that the waste wood sleepers of which pyrolysis is completed are recovered. For example, when the microwave applicator 300 moves to the adjacent reactor container 100, the oxygen blocking unit may cover an upper portion of the adjacent reactor container 100 of which pyrolysis is completed and may be installed to slidably move in the same manner as the microwave applicator 300, but is not limited thereto.

In addition, referring to FIG. 1, the waste wood sleeper pyrolysis apparatus 10 may further include a compressor 500, a pressure sensor 600, and a safety device 700 that are used to control pressures of the plurality of reactor containers 100.

The compressor 500 may control the pressures of the plurality of reactor containers 100 by supplying gases into the insides of the plurality of reactor containers 100. In order to recycle waste wood sleepers into adsorption materials and biofuels with high carbon content, a large micropore surface area, and a high calorific value, each of the plurality of reactor containers 100 has to be limited in oxygen and has to be in a high pressure condition. To this end, the compressor 500 may be connected to the plurality of reactor containers 100 to supply gases into the plurality of reactor containers 100, and thereby, insides of the plurality of reactor containers 100 may be in a high-pressure state. In this case, the above-described gases may include water vapor, carbon dioxide, nitrogen, inert gas, and so on, and may be injected into the plurality of reactor containers 100 as needed.

The above-described compressor 500 may be provided in each of the plurality of reactor containers 100 but is not limited thereto, and only one compressor 500 may be provided to control pressures of the plurality of reactor containers 100 through a branch pipe.

The pressure sensor 600 may detect an internal pressure of each of the plurality of reactor containers 100.

The safety device 700 may control pressures of the plurality of reactor containers 100 based on a pressure value received from the pressure sensor 600. For example, when detecting a pressure higher than the preset pressure, the pressure sensor 600 may discharge the gases inside the plurality of reactor containers 100 to the outside through the safety device 700.

Hereinafter, one of the plurality of reactor containers 100 according to an embodiment of the present disclosure will be described with reference to FIG. 2.

The plurality of reactor containers 100 according to an embodiment of the present disclosure may be configured for waste wood sleepers before crushing.

The plurality of reactor containers 100 may each include a doorway 110 which is formed on one side of each of the plurality of reactor containers 100 and through which a waste wood sleeper before crushing is introduced. As illustrated in FIG. 2, the plurality of reactor containers 100 may each receive and discharge a waste wood sleeper before crushing through the doorway 110 formed on one side, but is not limited thereto, and an inlet for introducing a waste wood sleeper before crushing may be formed on one side, and an outlet for discharging the reacted waste wood sleeper may be formed on the other side.

In addition, referring to FIGS. 2 and 5, the plurality of reactor containers 100 may each include a mesh 120 which is placed at the doorway 110 and in which a plurality of holes are formed. In this case, the plurality of holes formed in the mesh 120 may each have a diameter less than wavelengths of microwaves generated by the plurality of microwave generators 310. Accordingly, the microwaves do not leak to the outside of the plurality of reactor containers 100 and may be repeatedly moved only inside the plurality of reactor containers 100.

In addition, the plurality of reactor containers 100 may each further include an oil outlet 130 at the bottom through which bio-oil is discharged. Accordingly, bio-oil generated during a pyrolysis process may be easily discharged through the oil outlet 130.

Hereinafter, a reactor container 100 according to another embodiment of the present disclosure will be described with reference to FIG. 6.

The reactor container 100 according to another embodiment of the present disclosure may be configured for waste wood sleepers crushed into block shapes.

The reactor container 100 may include an inlet 140 which is formed on one side of an upper portion and through which the crushed waste wood sleeper is introduced, and an outlet 150 which is formed on the other side of a lower portion and through which the pyrolyzed waste wood sleeper is discharged.

In addition, the reactor container 100 may further include a paddle portion 160 for moving a crushed waste wood sleeper introduced inside the reactor container 100, and a paddle motor 170 that rotates the paddle portion 160. The paddle portion 160 may have both ends rotatably coupled to the reactor container 100 and include a plurality of paddles which causes the crushed waste wood sleeper to be moved from one side to the other side.

In addition, as illustrated in FIG. 6, the reactor container 100 may adjust an angle to slope downward from one side to the other side. Accordingly, not only a crushed waste wood sleeper introduced into the reactor container 100 may be moved smoothly, but also bio-oil formed during a pyrolysis process may be smoothly discharged.

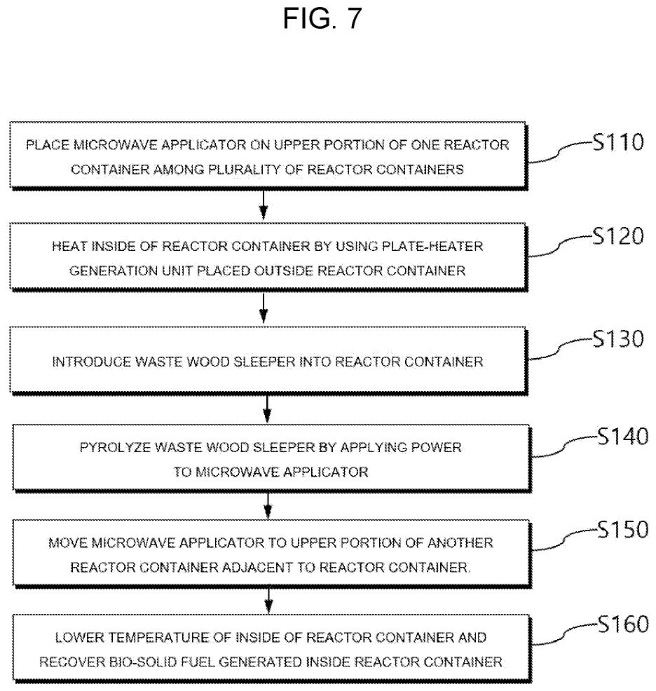

FIG. 7 is a flowchart illustrating a method of pyrolyzing waste wood sleepers by using the waste wood sleeper pyrolysis apparatus 10 of a hybrid heating type according to an embodiment of the present disclosure.

Hereinafter, a method of pyrolyzing waste wood sleepers by using the waste wood sleeper pyrolysis apparatus 10 according to an embodiment of the present disclosure will be described with reference to FIG. 7.

In step S110, the microwave applicator 300 is placed on an upper portion of the first reactor container 100 among the plurality of reactor containers 100. For example, referring to FIG. 3, the plurality of reactor containers 100 may be connected in parallel, and the microwave applicator 300 may be placed on the upper portion of the first reactor container 100 in the outermost position among the plurality of reactor containers 100, and the microwave applicator 300 may sequentially move and emit microwaves required for pyrolysis.

In step S120, the plate-heater generation unit 400 placed inside or outside the first reactor container 100 heats the inside of the first reactor container 100. Before a pyrolysis process for a waste wood sleeper is performed by the microwave applicator 300, the plate-heater generation unit 400 preheats the first reactor container 100 to increase the temperature of the inside of the first reactor container 100, and thus, there is an effect that the time required for the pyrolysis process may be reduced.

In step S130, a waste wood sleeper is introduced into the first reactor container 100.

In step S140, power is applied to the microwave applicator 300 to pyrolyze the waste wood sleeper. In this case, the contaminated gas generated inside the first reactor container 100 may be collected and purified by the gas purification device 900.

In step S150, the microwave applicator 300 moves to an upper portion of the second reactor container 100 adjacent to the first reactor container 100. In this case, the plate-heater generation unit 400 preheats the second reactor container 100 to increase the temperature of the inside of the second reactor container 100.

In step S160, the temperature of the inside of the second reactor container 100 is reduced, and a bio-solid fuel generated inside the first reactor container 100 is recovered. In this case, an oxygen blocking portion may be placed on an upper portion of the first reactor container 100 to prevent oxidation (Ash).

The waste wood sleeper pyrolysis apparatus 10 may repeatedly perform a pyrolysis process of pyrolyzing a waste wood sleeper by using one of the plurality of reactor containers 100 to generate bio-oil and/or bio-solid fuel, and then moving the microwave applicator 300 to an adjacent reactor container 100 to pyrolyze another waste wood sleeper, and then moving the microwave applicator 300 again to an adjacent reactor container 100 to pyrolyze another waste wood sleeper.

The above description of the present disclosure is for illustrative purposes, and those skilled in the art to which the present disclosure belongs will understand that the present disclosure may be easily modified into another specific form without changing the technical idea or essential features of the present application. Therefore, the embodiments described above should be understood in all respects as illustrative and not restrictive. For example, components described as a single form may be implemented in a distributed manner, and similarly, components described as a distributed manner may also be implemented in a combined form.

The scope of the present disclosure is indicated by the patent claims described below rather than the detailed description above, and all changes or modifications derived from the meaning and scope of the claims and their equivalent concepts are interpreted to be included in the scope of the present disclosure.

What is claimed is:

1. A waste wood sleeper pyrolysis apparatus of a hybrid heating type comprising:
a plurality of reactor containers arranged side by side, each having a space in which a waste wood sleeper is placed;
a movement rail arranged parallel to an end of one side and an end of the other side of each of the plurality of reactor containers; and
a microwave applicator coupled to the movement rail and including a plurality of microwave generators that move to upper portions of the plurality of reactor containers to transmit microwaves into the plurality of reactor containers.

2. The waste wood sleeper pyrolysis apparatus of claim 1, further comprising:
a plurality of plate-heater generation units respectively coupled to the plurality of reactor containers.

3. The waste wood sleeper pyrolysis apparatus of claim 1, wherein
the microwave applicator includes wheel portions respectively placed in one end and the other end of the movement rail and coupled to the movement rail.

4. The waste wood sleeper pyrolysis apparatus of claim 1, wherein each of the plurality of reactor containers includes:
a doorway for introducing the waste wood sleeper before crushing; and
a mesh which is placed in the doorway and in which a plurality of holes are formed.

5. The waste wood sleeper pyrolysis apparatus of claim 1, wherein
each of the plurality of reactor containers includes an oil outlet formed at a lower portion of each of the plurality of reactor containers to discharge bio-oil.

6. The waste wood sleeper pyrolysis apparatus of claim 1, wherein each of the plurality of reactor container includes:
an inlet formed on one side of an upper portion of each of the plurality of reactor containers to introduce a crushed waste wood sleeper; and
an outlet formed on one side of a lower portion of each of the plurality of reactor containers to discharge a pyrolyzed waste wood sleeper.

7. The waste wood sleeper pyrolysis apparatus of claim 6, wherein each of the plurality of reactor containers further includes:
a paddle portion for moving the crushed waste wood sleeper introduced inside each of the plurality of reactor containers; and
a paddle motor that rotates the paddle portion.

8. The waste wood sleeper pyrolysis apparatus of claim 1, further comprising:
a compressor that supplies gases into the plurality of reactor containers and controls pressures of the plurality of reactor containers.

9. The waste wood sleeper pyrolysis apparatus of claim 8, further comprising:
a pressure sensor that detects an internal pressure of each of the plurality of reactor containers; and
a safety device that controls the pressure of each of the plurality of reactor containers based on a pressure value received from the pressure sensor.

10. The waste wood sleeper pyrolysis apparatus of claim 1, wherein
the microwave applicator includes a quartz glass portion that is in contact with each of the plurality of reactor containers.

11. The waste wood sleeper pyrolysis apparatus of claim 1, further comprising:
microwave absorbers that are respectively placed inside the plurality of reactor containers and heat itself by microwave emitted from the microwave generator.

12. The waste wood sleeper pyrolysis apparatus of claim 1, further comprising:
oxygen blocking units that are respectively placed on upper portions of the plurality of reactor containers and prevent oxygen from flowing into the plurality of reactor containers from the outside.

13. The waste wood sleeper pyrolysis apparatus of claim 1, wherein
a gas purification device that is connected to the plurality of reactor containers and purifies and collects pollutant gases generated during a process of pyrolyzing the waste wood sleeper.

14. A method of pyrolyzing a waste wood sleeper by using a waste wood sleeper pyrolysis apparatus, the method comprising:
placing a microwave applicator on an upper portion of a first reactor container among a plurality of reactor containers;
heating an inside of the first reactor container by using a plate-heater generation unit inside or outside the first reactor container;
introducing the waste wood sleeper into the first reactor container;
pyrolyzing the waste wood sleeper by applying power to the microwave applicator;
moving the microwave applicator to an upper portion of a second reactor container adjacent to the first reactor container; and
reducing a temperature in the first reaction container and recovering a bio-solid fuel generated inside the first reactor container.

15. The method of claim 14, further comprising:
preheating an inside of the second reactor container by operating another plate-heater generation unit of the second reactor container adjacent to the first reactor container that is on pyrolysis.

16. The method of claim 14, wherein
the pyrolyzing of the waste wood sleeper includes collecting contaminant gas generated inside the first reactor container and purifying the collected gas by using a gas purification device.
